(19) United States
(12) Patent Application Publication
(10) Pub. No.: US 2014/0067359 A1
(43) Pub. Date: Mar. 6, 2014

(54) AUTOMATED ITERATIVE ERROR SIMULATION

(71) Applicants: Anton Arapov, Vranov (CZ); Jiri Olsa, Brno (CZ)

(72) Inventors: Anton Arapov, Vranov (CZ); Jiri Olsa, Brno (CZ)

(73) Assignee: RED HAT, INC., Raleigh, NC (US)

(21) Appl. No.: 13/603,089

(22) Filed: Sep. 4, 2012

(51) Int. Cl. G06F 9/45

(52) U.S. Cl. 703/22

(57) ABSTRACT

An example system may include error simulation capabilities. In one embodiment, the system obtains a configuration list associated with an application and a simulation trace associated with a first simulation of the application based on a simulation list. The configuration list comprises one or more functions associated with the application and one or more error return values for each function. The simulation list comprises zero or more functions to be executed during the first simulation. The system updates the simulation list based on the simulation trace. The system updates the simulation list based on the configuration list. The system updates the updated simulation list based on the configuration list. Upon determining that the updated simulation list comprises a function associated with the application, the system causes a second simulation of the application to be performed, wherein the second simulation is based on the updated simulation list.

### TECHNICAL FIELD

Embodiments of the present invention relate to error simulation, and more particularly, to a technique for automated iterative error simulation.

### BACKGROUND

Most modern computing systems, such as desktops and servers, include tools to allow a user to simulate errors in applications or in libraries used by applications on the computing system. These error simulation tools typically allow a user to simulate an error for any function used by an application or a dynamic library. Some error simulation tools enable a user to configure the error simulation. For example, the user can provide a customized error return value for a function executed by the application, such that a user knows that an error in the function has occurred when the user sees the customized return value once the simulation has completed.

A common error simulation tool can allow a user to customize the error simulation. The user can provide a list to the error simulation tool specifying one or more functions within the library or application in which to simulate an error. The user can further specify, in the list, an error return value for the function to return when the function is called during the error simulation. For example, the user can specify that function f1 should return an error return value of −1 by including “f1=−1” in the list. The user can also specify a number of times that the application should be simulated. If the user does not specify a number of times that the application should be simulated, the error simulation tool can execute the application a number of times that the specified function is included in the normal execution path of the application.

Each time the application is executed, the error simulation tool can simulate the function error on the next call of the function using the error value provided by the user. In one example, a user specifies an error value of −1 for a function f1 in a list, and runs an error simulation tool on an application with a normal execution path of: run function f1 with a default return value of 0, run function f2 with a default return value of 10, and run function f1 with a default return value of 0. In this example, the error simulation tool will run the application twice. The first run of the application will be with an execution path of: run function f1 with a return value of −1, run function f2 with a return value of 10, and run function f1 with a return value of 0. The second run of the application will be with an execution path of: run function f1 with a return value of 0, run function f2 with a return value of 10, and run function f1 with a return value of −1.

When the error simulation tool simulates an application being run, a new execution path for a function called by application can be created because of the change in the return value of the function. For example, an application or library may only call function f1 when a return value of a function f2 is equivalent to a certain value (e.g., 10). In this case, a new execution path will be created for an error simulation when the return value of function f2 is equivalent to the certain value. Typically, an error simulation tool does not simulate the application using the dynamically generated execution paths or dynamic function calls because the error simulation tool is usually not aware that the paths/function calls have been generated by the simulation.

Moreover, this type of error simulation tool typically only allows the user to simulate an error for one function at a time and using only a single error value for each error simulation. If a user wants to run an error simulation on a different function or using a different error value for a function, the user should run a new error simulation for the application. For example, a user can run an error simulation for function f1 and function f2 by providing a configuration list to the error simulation tool that includes one or more functions to simulate an error for and an error return value for the function(s). The error simulation tool will typically run an error simulation using the first function listed in the configuration list and use the first error return value listed for the function. The error simulation tool will typically stop the error simulation once each instance of the first function has been called using the first error return value. If the user would like to run an error simulation using return values for a second function listed in the configuration list or a different error return value for the first function, the user should start the error simulation tool again with a configuration list that includes the second function or different error return value for the first function. Moreover, the error simulation tool usually can only simulate the error on a function that is included in the normal execution path of the application.

### BRIEF DESCRIPTION OF THE DRAWINGS

Various embodiments of the present invention will be understood more fully from the detailed description given below and from the accompanying drawings of various embodiments of the invention.

FIG. 1 illustrates an example system architecture, in accordance with various embodiments of the present invention.

FIG. 2 is a block diagram of an error simulation module, in accordance with an embodiment.

FIG. 3 is a flow diagram illustrating an embodiment for a method of automated iterative error simulation, in accordance with an embodiment.

FIG. 4 is a flow diagram illustrating an embodiment for updating a simulation list based on a simulation trace, in accordance with an embodiment.

FIG. 5 is a flow diagram illustrating an embodiment for updating a simulation list based on a configuration list, in accordance with an embodiment.

FIG. 6 is a block diagram of an example computer system that may perform one or more of the operations described herein.

### DETAILED DESCRIPTION

Embodiments of the invention are directed to a method and system for automated iterative error simulation.

An error simulation tool can enable a user to simulate errors for multiple functions using multiple error values for the functions during an error simulation of an application. Moreover, the error simulation tool can determine dynamically generated execution paths and/or dynamic function calls that are created during the error simulation and ensure that a subsequent simulation of the application includes the dynamically generated execution paths and/or function calls.

The error simulation tool can obtain a configuration list that includes one or more functions associated with an application, and one or more error return values to use for each of the functions. The error simulation tool can perform a simulation for the application based on a simulation list. The simulation list can initially be empty for a first simulation for the application, and can subsequently include return values for each function to be executed during a subsequent simulation of the application. The error simulation tool can obtain a simulation trace from the error simulation that includes execution paths generated by the error simulation and/or functions called by the error simulation, including dynamically generated execution paths and/or dynamic function calls. The error simulation tool can update a simulation list to include the dynamically generated execution paths such that the dynamically generated execution paths and/or dynamic function calls are included in a subsequent simulation of the application. Moreover, the error simulation tool can update the return value for one or more functions in the simulation list. The return values listed in the updated simulation list can be used as the return values for those functions in the next simulation for the application based on the simulation list. The error simulation tool can subsequently perform an error simulation based on the simulation list. Moreover, after each error simulation, the error simulation tool can update the simulation list based on the configuration list and the simulation trace from the previous error simulation, and continue to perform error simulations based on the updated simulation list until the updated simulation list is empty.

By using and updating the simulation list based on a simulation trace from a previous error simulation, the error simulation tool can ensure that dynamically generated execution paths and/or dynamic function calls from the previous error simulation are included in a subsequent error simulation. Moreover, by using and updating the simulation list based on the configuration list, the error simulation tool can iterate through multiple functions using multiple error return values for the functions.

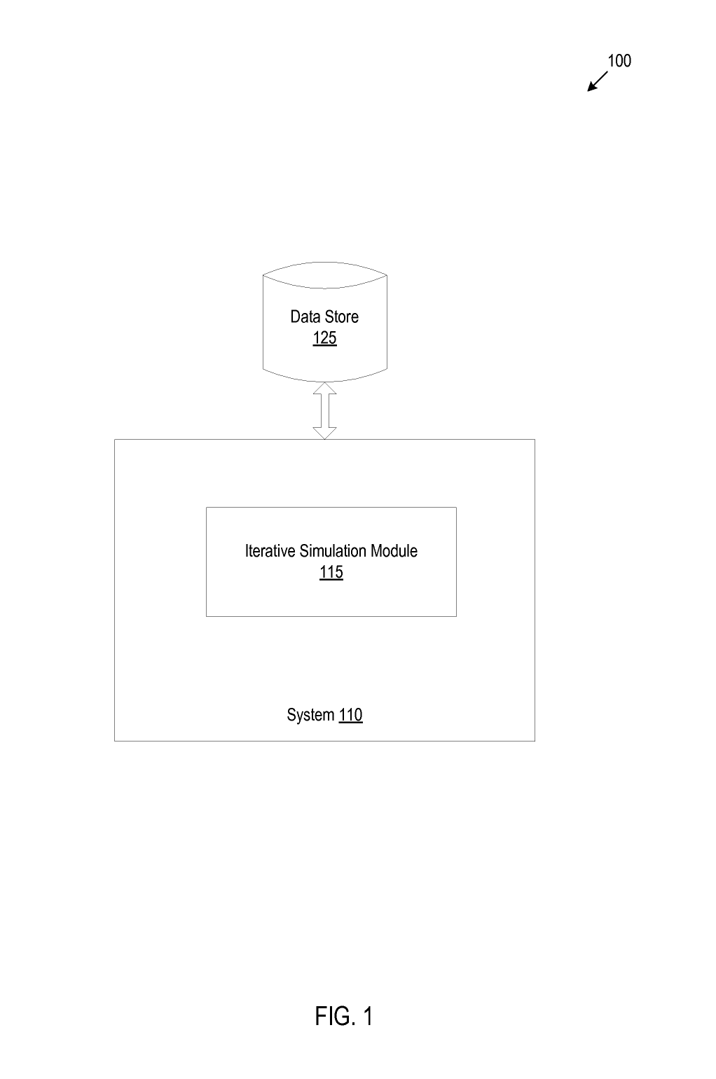

FIG. 1 illustrates an example system 100 in which embodiments can be implemented. System 100 may include computing devices that have a wide range of processing capabilities such a personal computer (PC), a server computer, a personal digital assistant (PDA), a smart phone, a laptop computer, a netbook computer, a tablet device, and/or any machine capable of executing a set of instructions (sequential or otherwise) that specify actions to be taken by that machine. Embodiments of the invention may operate within a single computing device or on multiple computing devices.

Data store 125 can be hosted by one or more writable persistent storage devices, such as memories, tapes or disks. In one embodiment, the one or more writable persistent storage devices are not Random Access Memory (RAM) devices, and can include devices such as hard drives, tapes, magnetic disks, optical disks, etc.

Although each of system 100 and data store 125 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices.

The data in the data store 125 can include data related to the system 100. Examples of data related to the system 100 can include, and are not limited to, configuration lists, simulation traces, and simulation lists for applications running on system 100, and any other electronically stored information that can be associated with a system, etc.

During operation of the system 100, the system 100 can have many processes executing on it, spawned by one or more applications that a user may want to simulate errors for. In one embodiment, the system 100 can include an iterative simulation module 115.

The iterative simulation module 115 can simulate the application to include an error in one or more functions used by an application running on the system 100. The error can be included by changing the return value for at least one function used by the application. The iterative simulation module 115 can customize the simulation for the function using a configuration list. The configuration list can include a list of functions and one or more error return values for each function to use to customize the simulation of the application. The error return value can represent a customized value (e.g., different than the default return value for the function) that the function should return upon executing or being called during the simulation of the application. In one embodiment, the configuration list is obtained from a user. In an alternate embodiment, the configuration list is obtained from a memory, such as data store 125.

The iterative simulation module 115 can obtain a simulation trace associated with an error simulation of the application. A simulation trace can be a file that lists all of the functions called by the simulation during the error simulation of the application. A simulation of the application can generate the simulation trace based on the execution paths generated by the error simulation or the functions called by the application during the simulation. The execution paths generated by the simulation can represent the functions called by the application during the error simulation of the application. The functions called by the application during the error simulation of the application can depend on the return values used for the functions during the error simulation. For example, an application may include the following code:

{

f1( );
if (f2( ) != 10)

f1( );

}

In this example, function f1 is only called if the return value of function f2 is not equal to 10. If a user customizes the return value of f2 in the configuration list, f1 may or may not be executed depending on the return value selected by the user. Therefore, the functions called by an application may vary depending on the return values of the functions. The functions that are called depending on the return values of the functions are called dynamically, and may generate dynamic execution paths.

Based on the configuration list and the simulation trace, the iterative simulation module 115 can update a simulation list associated with the application based on the simulation trace. The simulation list can include a list of functions and a respective return value for each function that should be used in the next simulation for the application. The iterative simulation module 115 can update the simulation list associated with the application by comparing the functions listed in the simulation list and functions listed in the simulation trace. The iterative simulation module 115 can add, to the simulation list, any functions or execution paths that are in the simulation trace but are not listed in the simulation list in order to include functions that have been dynamically executed by the previous simulation in a subsequent simulation. The iterative simulation module 115 can also add a return value for each added function.

Once the iterative simulation module 115 updates the simulation list based on the simulation trace, the iterative simulation module 115 can further update the simulation list based on the configuration list. The iterative simulation module 115 can determine if the simulation list includes a function that is also listed in the configuration list and if there is an unused return value for the function. If the simulation list includes a function that is also listed in the configuration list and if there is an unused return value for the function, the iterative simulation module 115 can update the return value of the function based on the unused return value. If the simulation list does not include a function that is also listed in the configuration list or if there is no unused return value for the function, the iterative simulation module 115 can remove the function from the simulation list, as there is no need to run an additional simulation using an error return value for the function.

Once the simulation list has been updated based on the simulation trace and the configuration list, the iterative simulation module 115 can determine whether the simulation list includes a function, requiring an additional simulation for the application. If the simulation list is empty, then no additional simulation may be necessary for the application because all dynamically generated execution paths have been simulated, and all return values for all functions listed in the configuration list have been iterated through and a simulation performed for each. If the iterative simulation module 115 determines that the simulation list includes a function, the iterative simulation module 115 can cause a simulation to be run or executed based on the simulation list. The iterative simulation module 115 can then obtain a new simulation trace for the error simulation, update the simulation list based on the new simulation trace and configuration list, determine whether the simulation list includes a function, and continue to iterate through these steps as long as there is a function in the simulation list.

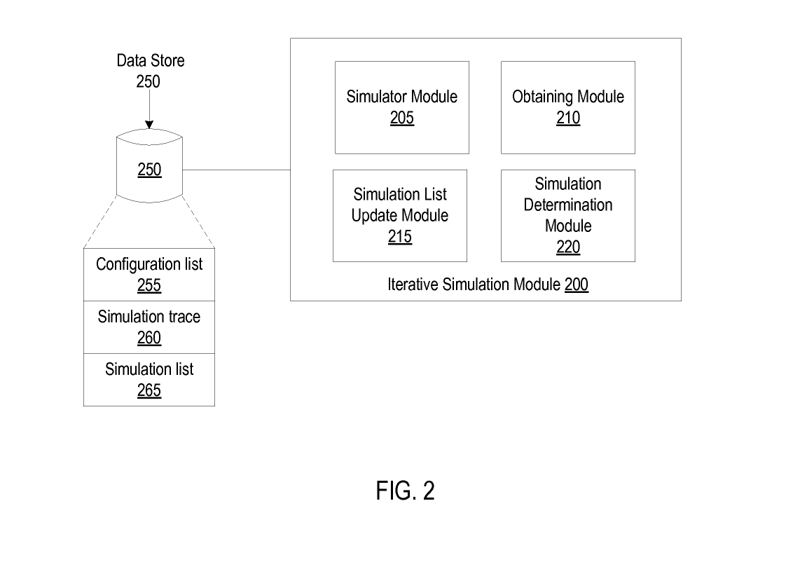

FIG. 2 is a block diagram of an iterative simulation module 200, in accordance with one embodiment of the present invention. The iterative simulation module 200 includes a simulator module 205, an obtaining module 210, a simulation list updating module 215, and a simulation determination module 220. Note that in alternative embodiments, the functionality of one or more of the simulator module 205, the obtaining module 210, the simulation list updating module 215, and the simulation determination module 220 may be combined or divided.

The simulator module 205 can include a simulation tool to run a simulation for an application using a simulation list, such as simulation list 265. The simulator module 205 can run an initial simulation for the application in response to receiving a request from a user to run the simulation. The simulator module 205 can run a subsequent simulation for the application in response to receiving a request from the simulation determination module 220 that the subsequent simulation is necessary for the application.

The simulator module 205 can generate a simulation trace for the simulation based on the execution paths generated by the simulation or the functions called by the application during the simulation. The execution paths generated by the simulation can represent the functions called by the application during the simulation of the application. The functions called by the application during the simulation of the application can depend on the return values used for the functions during the simulation. The simulator module 205 can run the simulation using return values for the functions used by the application as specified in a simulation list. During an initial simulation, the simulation list can be empty, and not include any functions or return values associated with the application being simulated. If a simulation list does not exist for an application, or is empty, the simulator module 205 can instruct the simulation tool to run the simulation of the application using default return values for the functions called by the application. The default return value can be a return value that a function returns when the application is not being simulated. As the simulator module 205 runs the simulation for the application, the simulator module 205 can record the functions called or executed by the application in the order that the functions are called in the simulation trace. Once the simulation for the application has completed, the simulator module 205 stores the simulation trace for the simulation in memory, such as simulation trace 260 in data store 250. In one embodiment, the simulator module 205 sends the simulation trace to the obtaining module 210 when the simulation has completed. In an alternate embodiment, the simulator module 205 sends the simulation trace to the obtaining module 210 when the simulator module 205 receives a request from the obtaining module 210 for the simulation trace.

The obtaining module 210 can obtain a configuration list for the application. The configuration list can include a list of functions with specific return values to use when a simulation is run for the application. In one embodiment, the configuration list represents customized return values from a user that would like to run an iterative error simulation for an application. A return value can represent a value that the function should return upon executing or being called during an simulation of the application. In one embodiment, the return value specified in the configuration list is different than a default return value for the function. In one embodiment, the obtaining module 210 can obtain the configuration list from a user. In an alternate embodiment, the obtaining module 210 can obtain the configuration list from a memory, such as configuration list 255 in data store 250. In another alternate embodiment, the obtaining module 210 can obtain the functions executed by a previous simulation for the application and copy the executed functions into a configuration list. The obtaining module 210 can store the obtained configuration list in configuration list 255 in data store 250.

The obtaining module 210 can obtain a simulation trace associated with a simulation of the application. In one embodiment, the obtaining module 210 obtains the simulation trace from a memory, such as simulation trace 260 in data store 250. In an alternate embodiment, the obtaining module 210 obtains the simulation trace by receiving the simulation trace from the simulator module 205 when the simulator module 205 has completed the simulation of the application. In another alternate embodiment, the obtaining module 210 obtains the simulation trace by providing a request to the simulator module 205 for the simulation trace and receiving the simulation trace from the simulator module 205 in response to the request.

The simulation list update module 215 can update a simulation list associated with the application based on the simulation trace and the configuration list. The simulation list can include a list of functions and a respective return value for each function that should be used in the next simulation for the application. The simulation list update module 215 can update the simulation list associated with the application by comparing the functions listed in the simulation list with the functions listed in the simulation trace. For the functions that are listed in the simulation trace but are not listed in the simulation list, the simulation list update module 215 can determine if the functions are also listed in the configuration list. If the simulation list update module 215 determines that one or more of the functions are also listed in the configuration list, the simulation list update module 215 can add the one or more functions to the simulation list.

The simulation list update module 215 can then determine if there is an unused return value for a function listed in the simulation list. If there is an unused return value for the function, the simulation list update module 215 updates the return value of the function based on the unused return value in order to ensure that each return value listed for each function in the configuration list is iterated through by the iterative simulation module 200. If there is no unused return value for the function, the simulation list update module 215 can remove the function from the simulation list, as there is no need to run a simulation using the function because all of the return values for that instance of the function in the simulation list has been iterated through. Once the function has been removed, the simulation list update module 215 can check another function in the simulation list (distinct from the removed function) and repeat the above process of determining if there is an unused return value for the function listed in the simulation list, and updating the return value of the function if there is an unused return value or removing the function from the simulation list if there is no unused return value. The simulation list update module 215 can continue this process until a function in the simulation list has an unused return value in the configuration list or until there are no additional functions listed in the simulation list.

Once the simulation list has been updated based on the simulation trace and the configuration list, the simulation list update module 215 can store the updated simulation list in a memory, such as simulation list 265 in data store 250. In one embodiment, once the simulation list has been updated based on the simulation trace and the configuration list, the simulation list update module 215 sends the updated simulation list to simulation determination module 220.

Simulation determination module 220 can determine whether another simulation is necessary for the application based on the simulation list. The simulation determination module 220 can make this determination in order to ensure that iterative simulation module 200 has iterated through each return value for each function listed in the configuration list. The simulation determination module 220 can determine whether another simulation is necessary for the application by determining whether the simulation list (as updated by the simulation list update module 215) includes a function. If the simulation determination module 220 determines that the simulation list does not include a function (and is therefore empty), then no additional simulation may be necessary for the application because all functions and return values have been used in a simulation of the application. If the simulation determination module 220 determines that the simulation list does include a function, the simulation determination module 220 can send a request to the simulator module 205 to initiate a simulation for the application using the simulation list.

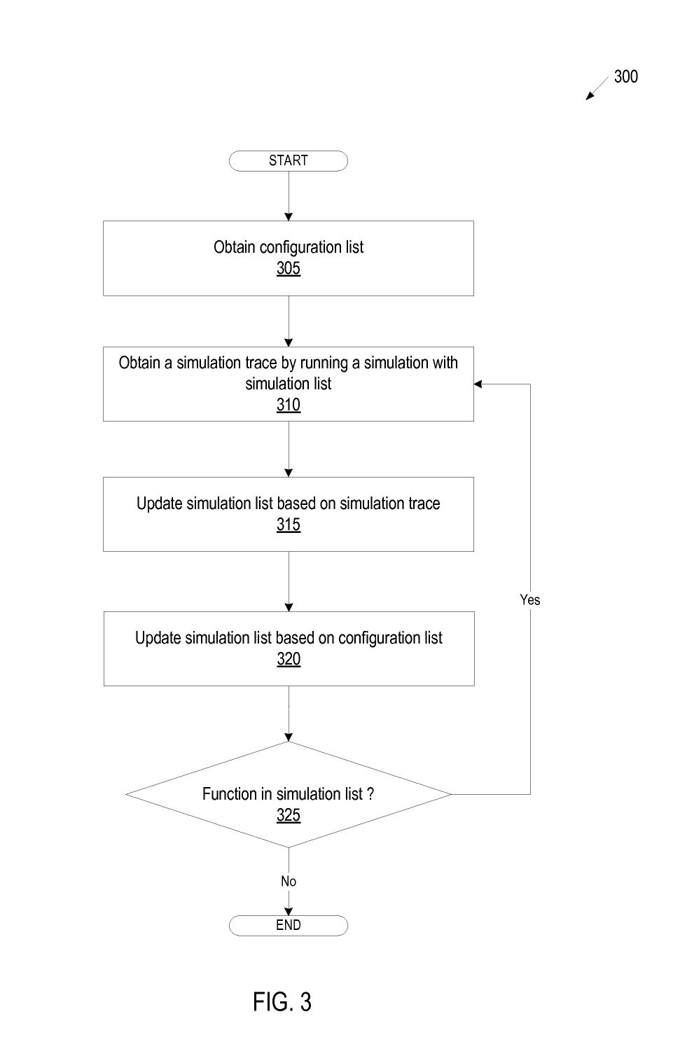

FIG. 3 is a flow diagram of an embodiment of a method 300 for method of automated iterative error simulation. The method 300 is performed by processing logic that may comprise hardware (circuitry, dedicated logic, etc.), software (such as is run on a general purpose computer system or a dedicated machine), or a combination of both. In one embodiment, the method 300 is performed by the iterative simulation module 200 of FIG. 2.

At block 305, processing logic obtains a configuration list for an application. An application can include one or more functions that execute when the application is running. The configuration list can include functions called or executed by the application. In one embodiment, the configuration list only includes the list of functions to simulate. In an alternate embodiment, the configuration list includes one or more return values for one or more of the functions listed in the configuration list. The configuration list can be used to customize the return values used during a simulation for the application. A return value can represent a value that the function should return upon executing or being called during an simulation of the application. For example, the configuration list lists the functions and error values as:
f1=−1
f2=−1, 0

Using the above configuration list, processing logic would simulate the application using the error return value of −1 for f1, −1 for f2, and 0 for f2 during multiple error simulation runs. In one embodiment, the configuration list is obtained from a user. In an alternate embodiment, the configuration list is obtained from a memory. In another alternate embodiment, the functions are determined from a previous error simulation for the application (e.g., using a simulation trace), and default error return values are selected for each of the determined functions. In yet another alternate embodiment, the functions are determined from a previous error simulation for the application (e.g., using a simulation trace), and random error return values are selected for each of the determined functions.

At block 310, processing logic obtains a simulation trace associated with a simulation of the application. The processing logic can obtain the simulation trace from a simulation tool that has completed a simulation of the application using a simulation list. In one embodiment, the simulation trace can include the execution paths taken by the simulation tool based on the functions called by the application during the simulation of the application. In an alternate embodiment, the simulation trace can include the functions called by the application during the simulation or execution of the application. The functions called by the application during the simulation of the application can depend on the return values used for the functions during the error simulation. For example, an application may include the following code:

{

f1( );
if (f2( ) != 10)

f1( );

}

In one example, a simulation uses a return value of −1 for f1 and 10 for f2. Using the previous return values, the simulation trace for a simulation of the application will include: f1, f2, and f1. In another example, the simulation uses a return value of −1 for f1 and 0 for f2. Using the previous return values, the simulation trace for the simulation will include f1 and f2.

The simulation list can include a list of functions with corresponding return values that a simulation tool can use when performing a simulation of the application. In one embodiment, during an initial simulation of the application, the simulation list is empty, such that the simulation of the application automatically uses the default return values for the functions called by the application. In an alternate embodiment, during an initial simulation of the application, the simulation list includes all the functions used by the application and the default return values for the functions.

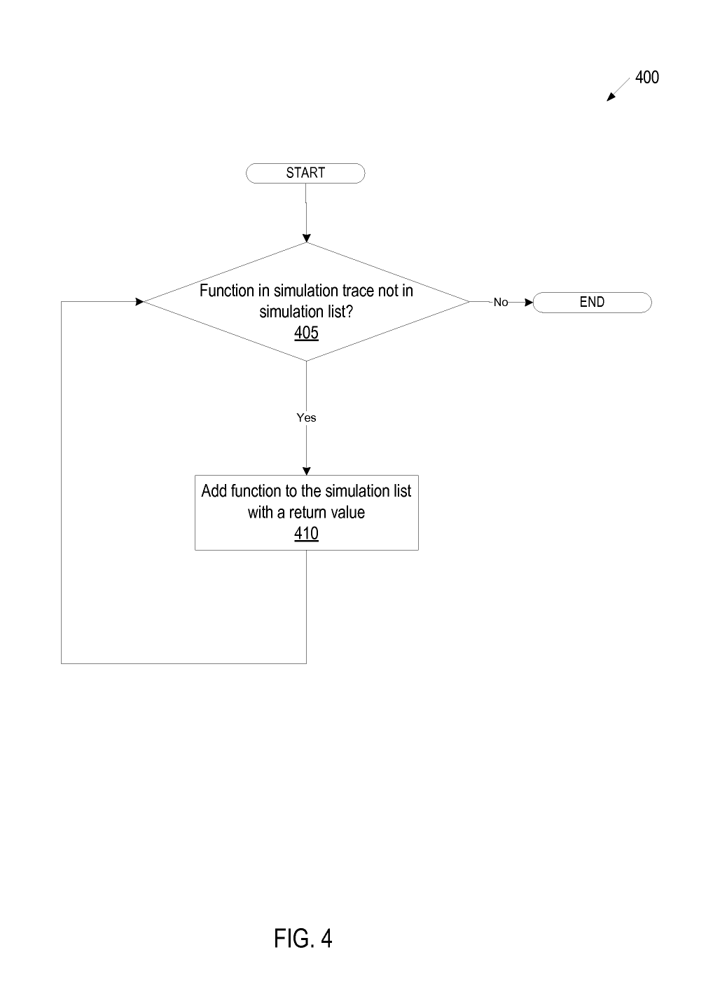

At block 315, processing logic updates the simulation list based on the simulation trace. Processing logic can update the simulation list based on the simulation trace to include the functions executed by the simulation of the application that produced the simulation trace, including functions that were called dynamically. One embodiment of a method for updating the simulation list based on the simulation trace is described in greater detail below in conjunction with FIG. 4.

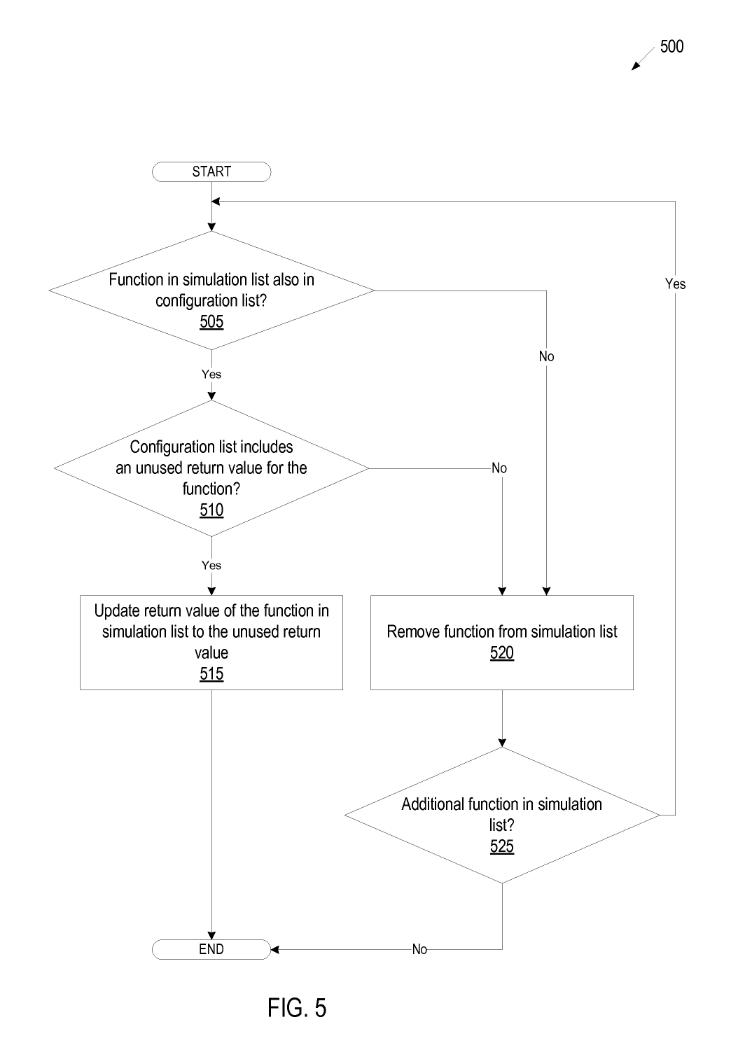

At block 320, processing logic updates the simulation list based on the configuration list. Processing logic can update the simulation list based on the configuration list to remove functions that the processing logic determines no longer need to be simulated. Processing logic can update the simulation list based on the configuration list to update the return values of the functions in the simulation list to iterate through each return value listed in the configuration list. One embodiment of a method for updating the simulation list based on the configuration list is described in greater detail below in conjunction with FIG. 5.

At block 325, processing logic determines whether there is a function or execution path in the simulation list. If processing logic determines that there is a function or execution path in the simulation list, the method 300 returns to block 310 to cause a simulation of the application to be run using the simulation list. In this case, the additional simulation of the application may be necessary because the simulation list includes at least one additional function with a return value that should be used in a simulation of the application. If processing logic determines that there is no function or execution path in the simulation list, then no additional simulations may be necessary for the application, and the method 300 ends.

FIG. 4 is a flow diagram of an embodiment of a method 400 for method of a updating a simulation list based on a simulation trace. The method 400 is performed by processing logic that may comprise hardware (circuitry, dedicated logic, etc.), software (such as is run on a general purpose computer system or a dedicated machine), or a combination of both. In one embodiment, the method 400 is performed by the iterative simulation module 200 of FIG. 2.

At block 405, processing logic determines whether the simulation trace from a simulation of an application includes a function or execution path that is not listed in the simulation list. Processing logic can determine whether the simulation trace includes a function or execution path that is not listed in the current simulation list by comparing identification information of each function in the simulation trace with identification information of each function in the current simulation list. In one embodiment, the identification information is a name of a function. In an alternate embodiment, the identification information is an execution path of a function. Functions that are not listed in the simulation list but are listed in the simulation trace may represent functions that were called dynamically during the simulation of the application. Execution paths that are not listed in the simulation list but are listed in the simulation trace may represent execution paths that were dynamically generated by the simulation of the application. If processing logic determines that there is no function or execution path in the simulation trace that is not in the simulation list, which means that all functions listed in the simulation trace are also listed in the simulation list, the method 400 ends. If processing logic determines that there is a function or execution path in the simulation trace that is not in the simulation list, the method 400 proceeds to block 410.

At block 410, processing logic updates the simulation list by adding the function to the simulation list with a return value for the function. In one embodiment, the return value for the function is determined based on a configuration list. One embodiment of a method for updating the simulation list based on a configuration list is described in greater detail below in conjunction with FIG. 5. In an alternate embodiment, the return value is a default return value for the function. In another alternate embodiment, the function is an error return value for the function.

For example, an application may include the following code:

{

f1( );
if (f2( ) != 10)

f1( );

}

The default return value for f1 can be 0 and the default return value for f2 can be 10. A first simulation of the application based on the above code could use a simulation list with an error return value for f1 of −1 and a default return value for f2 of 10. Alternatively, the first simulation may not use a simulation list, and may just run with default return values for functions f1 and f2. The first simulation will generate a simulation trace listing functions f1 and f2 as having been called and/or executed. Function f1 and f2 from the simulation trace will not be found in the simulation list. The simulation list will then be updated to include functions f1 and f2 and a return value for f1 and f2. For example, the updated simulation list will be:
f1=return value
f2=return value

Therefore, using the above example, the simulation list that is initially empty after a first simulation run will be updated to include functions f1 and f2 based on the simulation trace.

A second simulation using the above example may be run using the updated simulation list and a default return value of 0 for f1 and an error return value of −1 for f2. The second simulation will generate a simulation trace listing functions f1, f2, and f1 as having been called and/or executed. The second instance of f1 in the simulation trace will be determined to not be in the simulation list. The simulation list will then be updated to include function f2 and a return value for f2. For example, the updated simulation list will be:
f1=previous return value
f2=previous return value
f1=return value

FIG. 5 is a flow diagram of an embodiment of a method 500 for method of a updating a simulation list based on a configuration list. The method 500 is performed by processing logic that may comprise hardware (circuitry, dedicated logic, etc.), software (such as is run on a general purpose computer system or a dedicated machine), or a combination of both. In one embodiment, the method 500 is performed by the iterative simulation module 200 of FIG. 2.

At block 505, processing logic determines whether a function listed in a simulation list is also listed in a configuration list. In one embodiment, the function is the last function listed in the simulation list. In an alternate embodiment, the function is not the last function listed in the simulation list. In one embodiment, processing logic determines whether the function listed in the simulation trace is also listed in the configuration list by comparing identification information of the function to identification information of functions listed in the configuration list. In one embodiment, the identification information is a name of the function. In an alternate embodiment, the identification information is an execution path of the function.

At block 510, processing logic determines whether the configuration list includes an unused return value for the function. An unused return value for the function is a return value included in the configuration list that has not been assigned to the current instance of the function during a simulation of an application that includes the function. Processing logic can determine whether the configuration list includes an unused return value for the function by accessing the configuration list and searching for a numeric value next to the identification information for the function. In one embodiment, the numeric value is immediate to the right of the identification information for the function (e.g., f1 −1). In an alternate embodiment, the numeric value is on the other side of an operator (e.g., equal sign) next to the identification information for the function (e.g., f1=−1). In one embodiment, processing logic can determine whether the return value is unused by looking at one or more previous simulations to determine if each return value listed in the configuration file for the function has been used for the instance of the function. In another embodiment, processing logic can determine whether the return value is unused by using the first value listed in the configuration list for the function. If processing logic determines that the configuration list does not include an unused return value for the function, the method 500 proceeds to block 520. If processing logic determines that the configuration list includes an unused return value for the function, the method 500 proceeds to block 515.

At block 515, processing logic updates the return value of the function in the simulation list to the unused return value. Processing logic can update the return value of the function by overwriting a previous return value associated with (e.g., next to, on the other side of an operator of, etc.) the function. In one embodiment, the unused return value of the function is an error return value for the function. In an alternate embodiment, the unused return value is a customized return value for the function.

At block 520, processing logic removes the function from the simulation list. Processing logic can remove the function from the simulation list by deleting the function from the simulation list.

At block 525, processing logic determines whether there is an additional function in the simulation list. Processing logic determines whether there is an additional function in the simulation list by accessing the simulation list and determining whether the list is empty. If processing logic determines that there is an additional function in the simulation list, the method 500 proceeds to block 505. If processing logic determines that there is no additional function in the simulation list, the method 500 ends.

For example, an application may include the following code:

{

f1( );
if (f2( ) != 10)

f1( );

}

The default return value for f1 can be 0 and the default return value for f2 can be 10. A configuration list may include:
f1=−1
f2=−1, 0

Based on the example described above in conjunction with FIG. 4, an updated simulation list after a first simulation using default return values of the application will be:
f1=0
f2=10

In order to update the simulation list based on the configuration list, a determination is made of whether f2, which is the last function in the simulation list, is in the configuration list. The determination will be positive, since f2 is listed in the configuration list, and a determination will be made of whether there is an unused return value for f2. The determination will be positive since the return value of −1 has not been used for f2, and the return value of f2 will be updated to the unused return value. The updated simulation list will be:
f1=0
f2=−1

A second simulation using the above example will be run using the updated simulation list because there is still a function listed in the updated simulation list. The updated simulation list will be updated based on the simulation trace from the first simulation to include function f2 and a return value for f2. The updated simulation list will be:
f1=0
f2=−1
f1=0

In order to update the simulation list based on the configuration list, a determination is made of whether f1, which is the last function in the simulation list, is in the configuration list. The determination will be positive, since f1 is listed in the configuration list, and a determination will be made of whether there is an unused return value for f1. The determination will be positive, since the return value of −1 has not been used for f1, and the return value of f1 will be updated to the unused return value. The updated simulation list will be:
f1=0
f2=−1
f1=−1

A third simulation using the above example is run using the updated simulation list because there is still a function listed in the updated simulation list. The simulation trace from the second simulation will include:
f1=0
f2=−1
f1=−1

Because the simulation trace from the third simulation matches the updated simulation list (no dynamic function calls), the simulation list does not need to be updated based on the simulation trace. Therefore, the simulation list will be:
f1=0
f2=−1
f1=−1

In order to update the simulation list based on the configuration list, a determination is made of whether f1, which is the last function in the simulation list, is in the configuration list. The determination will be positive, since f1 is listed in the configuration list, and a determination will be made of whether there is an unused return value for f1. The determination will be negative, since there is only one return value in the configuration list for f1, and that return value was used in the previous (second) simulation run. The instance of f1 is then removed from the simulation list. The updated simulation list will be:
f1=0
f2=−1

A determination will be made if there is an additional function listed in the simulation list. The determination will be positive, since f1 and f2 are still listed in the simulation list. A determination is made of whether f2, which is now the last function in the simulation list, is in the configuration list. The determination will be positive, since f2 is listed in the configuration list, and a determination will be made of whether there is an unused return value for f2. The determination will be positive, since the return value of 0 for f2 has not been used, and the return value for f2 will be updated to the unused return value. The updated simulation list will be:
f1=0
f2=0

A fourth simulation using the above example is run using the updated simulation list because there is still a function listed in the updated simulation list. The simulation trace from the fourth simulation will include:
f1=0
f2=0
f1=0

The simulation list will be updated based on the simulation trace because the simulation trace includes a function that is not currently listed in the simulation list (the second instance of f1). The updated simulation list will be updated based on the simulation trace from the fourth simulation to include function f1 and a return value for f1. The updated simulation list will be:
f1=0
f2=0
f1=0

In order to update the simulation list based on the configuration list, a determination is made of whether f1, which is the last function in the simulation list, is in the configuration list. The determination will be positive, since f1 is listed in the configuration list, and a determination will be made of whether there is an unused return value for f1. The determination will be positive, since the return value of −1 has not been used for f1, and the return value of f1 will be updated to the unused return value. The updated simulation list will be:
f1=0
f2=0
f1=−1

A fifth simulation using the above example will be run using the updated simulation list because there is still a function listed in the updated simulation list. The simulation trace from the fifth simulation will include:
f1=0
f2=0
f1=−1

Because the simulation trace from the third simulation matches the updated simulation list (no dynamic function calls), the simulation list does not need to be updated based on the simulation trace. Therefore, the simulation list will be:
f1=0
f2=0
f1=−1

In order to update the simulation list based on the configuration list, a determination is made of whether f1, which is the last function in the simulation list, is in the configuration list. The determination will be positive, since f1 is listed in the configuration list, and a determination will be made of whether there is an unused return value for f1. The determination will be negative, since there is only one return value in the configuration list for f1, and that return value was used in the previous (fifth) simulation run. The instance of f1 is then removed from the simulation list. The updated simulation list will be:
f1=0
f2=0

A determination will be made if there is an additional function listed in the simulation list. The determination will be positive, since f1 and f2 are still listed in the simulation list. A determination is made of whether f2, which is now the last function in the simulation list, is in the configuration list. The determination will be positive, since f2 is listed in the configuration list, and a determination will be made of whether there is an unused return value for f2. The determination will be negative, since both the return values of 0 and −1 have been used. The instance of f2 is then removed from the simulation list. The updated simulation list will be:
f1=0

A determination will be made if there is an additional function listed in the simulation list. The determination will be positive, since f1 is still listed in the simulation list. A determination is made of whether f1, which is now the last function in the simulation list, is in the configuration list. The determination will be positive, since f1 is listed in the configuration list, and a determination will be made of whether there is an unused return value for f1. The determination will be positive, since the return value of −1 for this instance of f1 has not been used, and the return value for f1 will be updated to the unused return value. The updated simulation list will be:
f1=−1

A sixth simulation using the above example is run using the updated simulation list because there is still a function listed in the updated simulation list. The simulation trace from the sixth simulation will include:
f1=−1
f2=10

A determination will be made that there is a function in the simulation trace from the sixth simulation that is not in the simulation list (f2). The simulation list will be updated to include f2 and a return value for f2. The updated simulation list will be:
f1=−1
f2=10

In order to update the simulation list based on the configuration list, a determination is made of whether f2, which is the last function in the simulation list, is in the configuration list. The determination will be positive, since f2 is listed in the configuration list, and a determination will be made of whether there is an unused return value for f2. The determination will be positive, since the return value of −1 has not been used for f2 (because it is newly listed in the simulation list), and the return value of f2 will be updated to the unused return value. The updated simulation list will be:
f1=−1
f2=−1

A seventh simulation using the above example is run using the updated simulation list because there is still a function listed in the updated simulation list. The simulation trace from the seventh simulation will include:
f1=−1
f2=−1
f1=0

A determination will be made that there is a function in the simulation trace from the seventh simulation that is not in the simulation list (f1). The simulation list will be updated to include f1 and a return value for f1. The updated simulation list will be:
f1=−1
f2=−1
f1=0

In order to update the simulation list based on the configuration list, a determination is made of whether f1, which is the last function in the simulation list, is in the configuration list. The determination will be positive, since f1 is listed in the configuration list, and a determination will be made of whether there is an unused return value for f1. The determination will be positive, since the return value of −1 has not been used for f1 (because it is newly listed in the simulation list), and the return value of f1 will be updated to the unused return value. The updated simulation list will be:
f1=−1
f2=−1
f1=−1

An eighth simulation using the above example is run using the updated simulation list because there is still a function listed in the updated simulation list. The simulation trace from the eighth simulation will include:
f1=−1
f2=−1
f1=−1

Because the simulation trace from the eighth simulation matches the updated simulation list (no dynamic function calls), the simulation list does not need to be updated based on the simulation trace. Therefore, the simulation list will be:
f1=−1
f2=−1
f1=−1

In order to update the simulation list based on the configuration list, a determination is made of whether f1, which is the last function in the simulation list, is in the configuration list. The determination will be positive, since f1 is listed in the configuration list, and a determination will be made of whether there is an unused return value for f1. The determination will be negative, since there is only one return value in the configuration list for f1, and that return value was used in the previous (seventh) simulation run. The instance of f1 is then removed from the simulation list. The updated simulation list will be:
f1=−1
f2=−1

A determination will be made if there is an additional function listed in the simulation list. The determination will be positive, since f1 and f2 are still listed in the simulation list. A determination is made of whether f2, which is now the last function in the simulation list, is in the configuration list. The determination will be positive, since f2 is listed in the configuration list, and a determination will be made of whether there is an unused return value for f2. The determination will be positive, since the return value of 0 for f2 has not been used, and the return value for f2 will be updated to the unused return value. The updated simulation list will be:
f1=−1
f2=0

A ninth simulation using the above example is run using the updated simulation list because there is still a function listed in the updated simulation list. The simulation trace from the ninth simulation will include:
f1=−1
f2=0
f1=0

A determination will be made that there is a function in the simulation trace from the ninth simulation that is not in the simulation list (f1). The simulation list will be updated to include f1 and a return value for f1. The updated simulation list will be:
f1=−1
f2=0
f1=0

In order to update the simulation list based on the configuration list, a determination is made of whether f1, which is the last function in the simulation list, is in the configuration list. The determination will be positive, since f1 is listed in the configuration list, and a determination will be made of whether there is an unused return value for f1. The determination will be positive, since the return value of −1 has not been used for f1 (because it is newly listed in the simulation list), and the return value of f1 will be updated to the unused return value. The updated simulation list will be:
f1=−1
f2=0
f1=−1

A tenth simulation using the above example is run using the updated simulation list because there is still a function listed in the updated simulation list. The simulation trace from the tenth simulation will include:
f1=−1
f2=0
f1=−1

Because the simulation trace from the tenth simulation matches the updated simulation list (no dynamic function calls), the simulation list does not need to be updated based on the simulation trace. Therefore, the simulation list will be:
f1=−1
f2=0
f1=−1

In order to update the simulation list based on the configuration list, a determination is made of whether f1, which is the last function in the simulation list, is in the configuration list. The determination will be positive, since f1 is listed in the configuration list, and a determination will be made of whether there is an unused return value for f1. The determination will be negative, since there is only one return value in the configuration list for f1, and that return value was used in the previous (ninth) simulation run. The instance of f1 is then removed from the simulation list. The updated simulation list will be:
f1=−1
f2=0

A determination will be made if there is an additional function listed in the simulation list. The determination will be positive, since f1 and f2 are still listed in the simulation list. A determination is made of whether f2, which is now the last function in the simulation list, is in the configuration list. The determination will be positive, since f2 is listed in the configuration list, and a determination will be made of whether there is an unused return value for f2. The determination will be negative, since both return values (0 and −1) in the configuration list for f2 have been used in previous (eighth and ninth) simulation runs. The instance of f2 is then removed from the simulation list. The updated simulation list will be:
f1=−1

A determination will be made if there is an additional function listed in the simulation list. The determination will be positive, since f1 is still listed in the simulation list. A determination is made of whether f1, which is now the last function in the simulation list, is in the configuration list. The determination will be positive, since f1 is listed in the configuration list, and a determination will be made of whether there is an unused return value for f1. The determination will be negative, since the return value of −1 in the configuration list for f1 has been used in a previous (ninth) simulation run. The instance of f1 is then removed from the simulation list. The updated simulation list will be empty, and will have no functions listed. A determination will be made that there is no additional function in the simulation list, and the automatic iterative error simulation of the application will end.

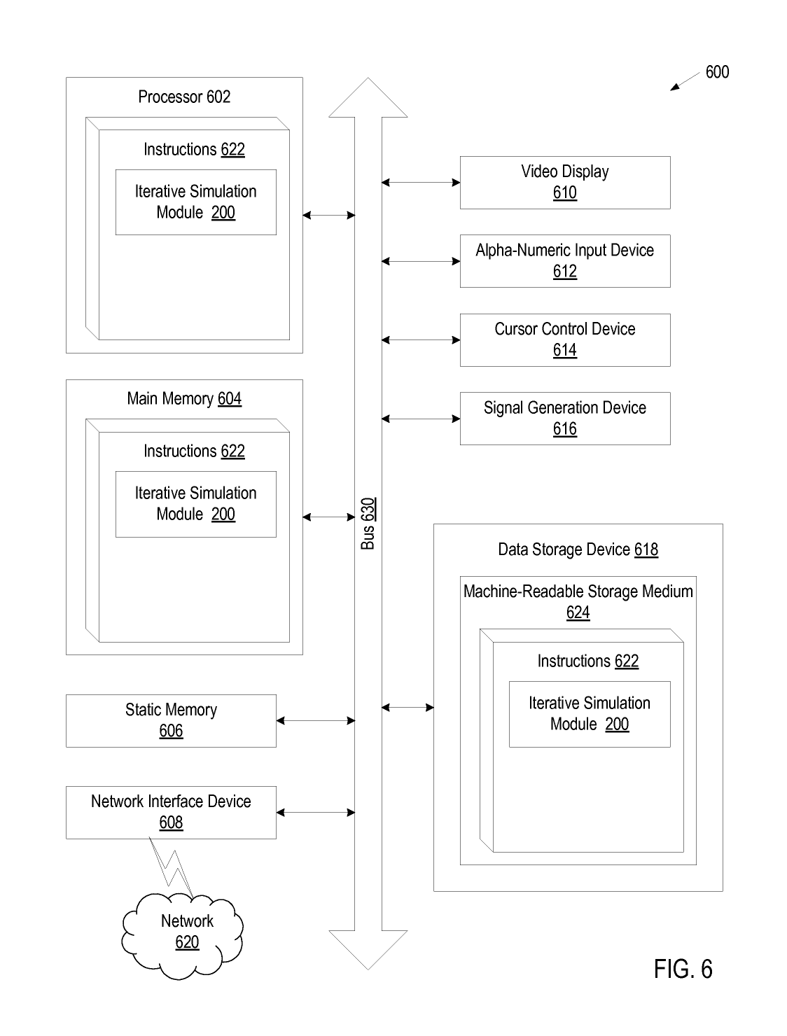

FIG. 6 illustrates a diagrammatic representation of a machine in the form of a computer system 600 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 600 includes a processing device (processor) 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 608.

Processor 602 represents one or more general-purpose processing devices such as a microprocessor, central processing unit, or the like. More particularly, the processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 602 may also be one or more special-purpose processing devices such as an application specific integrated circuit (ASIC), a field programmable gate array (FPGA), a digital signal processor (DSP), network processor, or the like. The processor 602 is configured to execute instructions 626 for performing the operations and steps discussed herein.

The computer system 600 may further include a network interface device 622. The computer system 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 618 may include a computer-readable storage medium 624 on which is stored one or more sets of instructions 626 (e.g., software) embodying any one or more of the methodologies or functions described herein. The instructions 626 may also reside, completely or at least partially, within the main memory 604 and/or within the processor 602 during execution thereof by the computer system 600, the main memory 604 and the processor 602 also constituting computer-readable storage media. The instructions 626 may further be transmitted or received over a network 620 via the network interface device 622.

In one embodiment, the instructions 626 include instructions for an iterative simulation module 200, and/or a software library containing methods that automate iterative error simulation. While the computer-readable storage medium 624 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, in order to avoid obscuring the present invention.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “segmenting”, “analyzing”, “determining”, “enabling”, “identifying,” “modifying” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
obtaining, by a computing system, a configuration list associated with an application, the configuration list comprising one or more functions associated with the application and one or more error return values for each function;
obtaining, by the computing system, a simulation trace associated with a first simulation of the application based on a simulation list, the simulation list comprising zero or more functions to be executed during the first simulation;
updating, by the computing system, the simulation list based on the simulation trace;
updating, by the computing system, the updated simulation list based on the configuration list; and
upon determining that the updated simulation list comprises a function associated with the application, causing, by the computing system, a second simulation of the application to be performed, wherein the second simulation is based on the updated simulation list.

2. The method of claim 1, further comprising:
performing the updating the simulation list, the updating the updated simulation list, and the causing until the updated simulation list does not comprise a function associated with the application.

3. The method of claim 1, wherein the simulation trace comprises a function used by the application during an error simulation of the application.

4. The method of claim 1, wherein updating the simulation list based on the simulation trace comprises:
determining whether the simulation trace comprises a function not listed in the simulation list; and
upon determining that the configuration list comprises the function, adding the function to the simulation list.

5. The method of claim 4, wherein adding the function to the simulation list comprises:
including an identification of the function to the simulation list; and
associating a default return value with the function in the simulation list.

6. The method of claim 1, wherein updating the simulation list based on the configuration list comprises:
determining whether a function in the simulation list is included in the configuration list;
upon determining that a function in the simulation list is not included in the configuration list, removing the function from the simulation list;
upon determining that a function in the simulation list is included in the configuration list, determining whether the configuration list includes an unused return value associated with the function;
upon determining that the configuration list comprises an unused return value associated with the function, adding the unused return value associated with the function to the simulation list; and
upon determining that the configuration list does not comprise an unused return value associated with the function, removing the function from the simulation list.

7. The method of claim 6, further comprising:
upon determining that the configuration list does not comprise an unused return value associated with the function, determining whether the configuration list comprises an unused return value associated with another function listed in the simulation list.

8. The method of claim 6, wherein the function is a last function listed in the simulation list.

9. A non-transitory computer readable storage medium having instructions that, when executed by a processing device, cause the processing device to perform operations comprising:
obtaining, by the processing device, a configuration list associated with an application, the configuration list comprising one or more functions associated with the application and one or more error return values for each function;
obtaining, by the processing device, a simulation trace associated with a simulation of the application based on a simulation list, the simulation list comprising zero or more functions to be executed during the first simulation;
updating, by the processing device, the simulation list based on the simulation trace;
updating, by the processing device, the updated simulation list based on the configuration list; and
upon determining that the updated simulation list comprises a function associated with the application, causing, by the processing device, a second simulation of the application to be performed, wherein the second simulation is based on the updated simulation list.

10. The non-transitory computer readable storage medium of claim 9, having instructions that, when executed by a processing device, cause the processing device to perform operations further comprising:
performing the updating the simulation list, the updating the updated simulation list, and the causing until the updated simulation list does not comprise a function associated with the application.

11. The non-transitory computer readable storage medium of claim 9, wherein updating the simulation list based on the simulation trace comprises:
determining whether the simulation trace comprises a function not listed in the simulation list; and
upon determining that the configuration list comprises the function, adding the function to the simulation list.

12. The non-transitory computer readable storage medium of claim 11, wherein adding the function to the simulation list comprises:
including an identification of the function to the simulation list; and
associating a default return value with the function in the simulation list.

13. The non-transitory computer readable storage medium of claim 9, wherein updating the simulation list based on the simulation trace and the configuration list comprises:
determining whether a function in the simulation list is included in the configuration list;
upon determining that a function in the simulation list is not included in the configuration list, removing the function from the simulation list;
upon determining that a function in the simulation list is included in the configuration list, determining whether the configuration list includes an unused return value associated with the function;
upon determining that the configuration list comprises an unused return value associated with the function, adding the unused return value associated with the function to the simulation list; and
upon determining that the configuration list does not comprise an unused return value associated with the function, removing the function from the simulation list.

14. The non-transitory computer readable storage medium of claim 13 having instructions that, when executed by a processing device, cause the processing device to perform operations further comprising:
upon determining that the configuration list does not comprise an unused return value associated with the function, determining whether the configuration list comprises an unused return value associated with another function listed in the simulation list.

15. A computing device comprising:
a memory; and
a processing device coupled to the memory, wherein the processing device is configured to:
obtain a configuration list associated with an application, the configuration list comprising one or more functions associated with the application and one or more error return values for each function;
obtain a simulation trace associated with a first simulation of the application based on a simulation list, the simulation list comprising zero or more functions to be executed during the first simulation;
update a simulation list based on the simulation trace;
update the updated simulation list based on the configuration list; and
upon determining that the updated simulation list comprises a function associated with the application, cause a second simulation of the application to be performed, wherein the second simulation is based on the updated simulation list.

16. The computing device of claim 15, wherein the processing device is further configured to:
perform the updating the simulation list, the updating the updated simulation list, and the causing until the updated simulation list does not comprise a function associated with the application.

17. The computing device of claim 15, wherein to update the simulation list based on the simulation trace and the configuration list, the processing device is further configured to:
determine whether the simulation trace comprises a function not listed in the simulation list; and
upon determining that the configuration list comprises the function, add the function to the simulation list.

18. The computing device of claim 17, wherein to add the function to the simulation list, the processing device is further configured to:
including an identification of the function to the simulation list; and
associate a default return value with the function in the simulation list.

19. The computing device of claim 15, wherein to update the simulation list based on the configuration list, the processing device is further configured to:
determine whether a function in the simulation list is included in the configuration list;
upon determining that a function in the simulation list is not included in the configuration list, remove the function from the simulation list;
upon determining that a function in the simulation list is included in the configuration list, determine whether the configuration list includes an unused return value associated with the function;
upon determining that the configuration list comprises an unused return value associated with the function, add the unused return value associated with the function to the simulation list; and
upon determining that the configuration list does not comprise an unused return value associated with the function, remove the function from the simulation list.

20. The computing device of claim 19, wherein the processing device is further configured to:
upon determining that the configuration list does not comprise an unused return value associated with the function, determine whether the configuration list comprises an unused return value associated with another function listed in the simulation list.
